(19) United States
(12) Patent Application Publication
(10) Pub. No.: US 2026/0040311 A1
(43) Pub. Date: Feb. 5, 2026

(54) MANAGING CO-EXISTENCE EVENT IN WIRELESS COMMUNICATION NETWORK

(71) Applicant: Samsung Electronics Co., Ltd., Suwon-si (KR)

(72) Inventors: Manasi EKKUNDI, Bengaluru (IN); Karthik Srinivasa GOPALAN, Bengaluru (IN)

(21) Appl. No.: 19/351,545

(22) Filed: Oct. 7, 2025

Related U.S. Application Data
(63) Continuation of application No. PCT/KR2025/010851, filed on Jul. 23, 2025.

(30) Foreign Application Priority Data
Jul. 26, 2024 (IN) 2024 41056974
Jul. 10, 2025 (IN) 202441056974

(51) Int. Cl. H04W 72/20; H04W 88/08

(52) U.S. Cl. CPC H04W 72/20; H04W 88/08

(57) ABSTRACT

Techniques for managing a co-existence event in a wireless communication network. A method may include predicting, within or after a predefined threshold time interval, an occurrence of the co-existence event at an access point (AP) of the wireless communication network. A method may include selecting, based on the prediction, a signaling technique from among a plurality of predefined signaling techniques for transmitting a co-existence information associated with the co-existence event. The co-existence information may include at least a start time and a duration of the co-existence event. The method may include transmitting the co-existence information to one or more stations (STAs) associated with the AP using the selected transmission mechanism.

### CROSS-REFERENCE TO RELATED APPLICATIONS

This application is a continuation application of International Application No. PCT/KR2025/010851 designating the United States, filed on Jul. 23, 2025, in the Korean Intellectual Property Receiving Office and claiming priority to Indian Provisional Patent Application No. 202441056974, filed on Jul. 26, 2024, and Indian Complete patent application No. 202441056974, filed on Jul. 10, 2025, the disclosures of which are all hereby incorporated by reference herein in their entireties.

### TECHNICAL FIELD

Certain example embodiments may relate to wireless communication, and for example to systems and/or methods for managing a co-existence event in a wireless communication network.

### BACKGROUND

Wireless communication systems often rely on channel access mechanisms to manage how multiple devices share a common communication medium. One such mechanism is Enhanced Distributed Channel Access (EDCA), as introduced in Institute of Electrical and Electronics Engineers (IEEE) 802.11e. FIG. 1 illustrates the EDCA mechanism 100, in accordance with related art. The EDCA mechanism 100 prioritizes traffic by implementing different access categories, allowing time-sensitive data (like voice and video) to be transmitted with lower latency. In particular, the EDCA mechanism 100 implements a contention-based approach, where mobile devices (also referred to as a station) compete for channel access based on a corresponding priority level. A Transmit Opportunity (TXOP) is set to be initiated when EDCA rules permit access to the medium. FIG. 1 illustrates an access to a communication medium by a station (STA) through EDCA called a TXOP holder. As shown in FIG. 1, the TXOP holder first initiates the TXOP by transmitting a control message sequence to establish a coordinated exchange with a peer STA, hereafter referred to as the TXOP responder. This control exchange may include conventional Request-to-Send (RTS)/Clear-to-Send (CTS) frames, Multi-User RTS/CTS (MU-RTS/CTS), or generalized signaling using Initial Control Frame (ICF) and Initial Control Frame Response (ICR). The purpose of this exchange is to secure the medium, notify neighboring STAs of the forthcoming transmission via the Network Allocation Vector (NAV), and prepare the TXOP responder for an upcoming data transaction.

Following the control exchange and a Short Inter-Frame Space (SIFS), the TXOP holder may proceed with transmitting data using one or more Physical Layer Protocol Data Units (PPDUs). These PPDUs may involve uplink, downlink, or bi-directional communication depending on the session type. The NAV information derived from the initial control exchange ensures that other STAs in a Basic Service Set (BSS) defer their access attempts during the TXOP window, thereby maintaining a contention-free period for uninterrupted data delivery. The TXOP holder may optionally transmit a Contention-Free End (CF-end) frame to explicitly signal the end of its TXOP, thereby allowing other STAs to resume contention.

Further, modern devices often integrate multiple wireless technologies, such as Bluetooth (BT), Ultra-Wide Band (UWB), New Radio (NR)/5G, Zigbee, and Peer-to-Peer (P2P) Wi-Fi in a single form factor. These coexisting technologies can interfere with each other, leading to what is termed an in-device co-existence event, or “co-ex event.” For instance, the transmission/reception of one technology (e.g., Bluetooth) can hamper the reception/transmission of another technology (e.g., Wi-Fi), potentially resulting in lost Acknowledgments (ACKs) and forcing data retransmissions or reduced throughput. This phenomenon creates a double punishment, where packet loss due to co-existence issues causes the sender to reduce its data rate or repeat failed transmissions.

When the co-ex event occurs, the communication with an Access Point (AP) or the STA experiences interference, and constraints can be set up on parameters such as time, frequency, and spatial streams. In particular, the co-ex event can occur at the time of operation when a transmission or reception is scheduled. Further, the co-ex event can occur at a specific frequency of operation. Similarly, the co-ex event can impact the operation of a number of spatial streams. Usually, co-ex events can be categorized into periodic and non-periodic events. For periodic co-ex events, existing mechanisms in 802.11 technologies like P2P Target-wake-time (TWT) can be used to enhance the support of such co-ex events. For urgent/aperiodic co-ex events, various mechanisms are explored to control frames that can reduce the capability within the TXOP due to the co-ex events based on factors such as time (time of availability or unavailability), frequency (reduced bandwidth), reduced spatial streams, and so on.

Some conventional solutions propose that the AP/STA can add to the ICF/ICR, including the target availability/unavailability start time and time of the co-ex event. FIG. 2 illustrates a scenario 200 to mitigate the interference effect during the co-ex event, in accordance with related art. As shown in FIG. 2, an Access Point (AP) 202 initiates an ICF directed to a specific STA 204. Unlike traditional ICFs, this frame carries additional metadata concerning the anticipated co-ex event at the AP 202. This metadata may include fields such as the co-ex event's start time, expected duration, affected frequencies or spatial streams, and a general availability/unavailability profile. Upon receiving the ICF, the STA 204 (also referred to as the TXOP responder) evaluates the information and responds with an ICR. This response may likewise include the STA's availability or co-ex event profile, enabling mutual awareness between the AP 202 and the STA 204 regarding potential disruptions during the TXOP window. This exchange provides both the AP 202 and the STA 204 with contextual awareness of potential unavailability due to internal co-existence conflicts. Accordingly, the AP 202 and the STA 204 can intelligently adapt their TXOP duration, defer transmissions, reschedule packet delivery, or reallocate resources (e.g., spatial streams) to avoid interference. This mitigation approach is particularly valuable in ensuring low-latency and reliable performance during urgent or aperiodic co-ex events, where conventional scheduling mechanisms, such as TWT, may not be applicable. Further, the existing mechanism is particularly useful in the context of multi-radio devices, such as those supporting Wi-Fi alongside Bluetooth, UWB, or 5G, which may suffer from cross-interface interference that degrades transmission reliability or responsiveness.

Despite existing techniques aimed at managing Ultra High Reliability (UHR) or 802.11bn-specific in-device co-existence, several challenges persist. One of the primary issues is that the STAs not directly involved in ICF or ICR exchanges remain unaware of co-existence (co-ex) events occurring at the AP. Such STAs are herein referred to as uninformed STAs. These uninformed STAs, which are not actively scheduled for communication with the AP, do not receive updates about ongoing co-ex events. As a result, these uninformed STAs may unknowingly attempt to access the channel by retransmitting ICFs during a period when the AP is unavailable due to a co-ex event. This behavior leads to unnecessary retransmissions, increased power consumption, and inefficient use of airtime resources.

Further, the presence of multiple uninformed STAs within a BSS can complicate medium access. While some STAs experience high overhead due to repeated failed attempts, others may be entirely blocked from accessing the medium. Such a problem is often caused by NAV settings triggered by these repeated attempts, unintentionally preventing or reducing fair medium access among neighboring STAs.

Further, after a co-ex event concludes, both informed and uninformed STAs may simultaneously attempt to access the medium, increasing the likelihood of collisions. Such collisions not only disrupt communication but also degrade the overall efficiency and reliability of the network.

The description set forth in the background section should not be assumed to be prior art merely because it is set forth in the background section. The background section may describe aspects or embodiments of the present disclosure.

### SUMMARY

This summary is provided to introduce a selection of concepts, in a simplified format, that are further described in the detailed description of the invention. This summary is neither intended to identify key or essential inventive concepts of the invention nor is it intended for determining the scope of the invention.

According to an example embodiment, disclosed herein is a method for managing a co-existence event in a wireless communication network. The method includes predicting, within or after a predefined threshold time interval, an occurrence of the co-existence event at an access point (AP) of the wireless communication network. The method includes selecting, based on the prediction, a signaling technique from a plurality of signaling techniques for transmitting a co-existence information associated with the co-existence event. The co-existence information includes at least a start time and a duration of the co-existence event. The method includes transmitting the co-existence information to one or more stations (STAs) associated with the AP using the selected transmission mechanism.

According to an example embodiment, disclosed herein is a system for managing a co-existence event in a wireless communication network. The system includes a memory and at least one processor comprising processing circuitry. The at least one processor is coupled, directly or indirectly, to the memory and is individually and/or collectively configured to predict, within or after a predefined threshold time interval, an occurrence of the co-existence event at an access point (AP) of the wireless communication network. The at least one processor may be individually and/or collectively configured to select, based on the prediction, a signaling technique from among a plurality of predefined signaling techniques for transmitting a co-existence information associated with the co-existence event. The co-existence information may include at least a start time and a duration of the co-existence event. The at least one processor may be individually and/or collectively configured to control to transmit the co-existence information to one or more stations (STAs) associated with the AP using the selected transmission mechanism.

To further clarify the advantages and features, a more particular description will be rendered by reference to specific embodiments thereof, which are illustrated in the appended drawing. It is appreciated that these drawings depict only typical embodiments of the invention and are therefore not to be considered limiting its scope. The invention will be described and explained with additional specificity and detail with the accompanying drawings.

### BRIEF DESCRIPTION OF THE DRAWINGS

These and other features, aspects, and advantages will become better understood when the following detailed description is read with reference to the accompanying drawings in which like characters represent like parts throughout the drawings.

FIG. 1 illustrates an Enhanced Distributed Channel Access (EDCA) mechanism, in accordance with related art.

FIG. 2 illustrates a scenario to mitigate the interference effect during co-ex event, in accordance with related art.

FIG. 3 illustrates a Basic Service Set (BSS) environment depicting a co-ex event, in accordance with related art.

FIG. 4A illustrates a scenario depicting an overhead problem in the co-ex event, in accordance with related art.

FIG. 4B illustrates a scenario depicting a medium blocked problem in the co-ex event, in accordance with related art.

FIG. 4C illustrates a scenario depicting a collision problem in the co-ex event, in accordance with related art.

FIG. 5 illustrates an exemplary wireless communication network, in accordance with an example embodiment.

FIG. 6 illustrates a block diagram of a system for managing the co-existence event in the wireless communication network, in accordance with an example embodiment.

FIG. 7A illustrates a beacon frame with co-existence information, in accordance with an example embodiment.

FIG. 7B illustrates a message sequence of the beacon frame with the co-existence information, in accordance with an example embodiment.

FIG. 8A illustrates a broadcast message with the co-existence information, in accordance with an example embodiment.

FIG. 8B illustrates a message sequence of the broadcast message with the co-existence information, in accordance with an example embodiment.

FIG. 9 illustrates a scenario depicting the co-existence event when a Station (STA) as an Access Point (AP) is a Transmit Opportunity (TXOP) holder, in accordance with related art.

FIG. 10A illustrates a Multi-User Broadcast (MU-BCS) frame with the co-existence information, in accordance with an example embodiment.

FIG. 10B illustrates a Trigger Frame-Request to Send (TF-RTS) frame with the co-existence information, in accordance with an example embodiment.

FIG. 10C illustrates a message sequence of the MU-BCS frame and the TF-RTS frame, in accordance with an example embodiment.

FIG. 11A illustrates a Release With Information (RWI) frame, in accordance with an example embodiment.

FIG. 11B illustrates a message sequence of the RWI frame, in accordance with an example embodiment.

FIG. 12 illustrates an Initial Control Frame, in accordance with an example embodiment.

FIG. 13 illustrates an MU-RTS frame, in accordance with an example embodiment.

FIG. 14 illustrates a message sequence of the Initial Control Frame, in accordance with an example embodiment.

FIG. 15 illustrates a flow diagram depicting a method for managing the co-existence event in the wireless communication network, in accordance with an example embodiment.

Further, skilled artisans will appreciate that those elements in the drawings are illustrated for simplicity and may not have necessarily been drawn to scale. For example, the flow charts illustrate the method in terms of the most prominent steps involved to help improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the present disclosure, reference will now be made to the various embodiments, and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Whether or not a certain feature or element was limited to being used only once, it may still be referred to as “one or more features” or “one or more elements” or “at least one feature” or “at least one element.” Furthermore, the use of the terms “one or more” or “at least one” feature or element does not preclude there being none of that feature or element, unless otherwise specified by limiting language including, but not limited to, “there needs to be one or more . . . ” or “one or more elements is required.”

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfill the requirements of uniqueness, utility, and/or the like.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items. The phrase “one or more of,” when used with a list of items, means that different combinations of one or more of the listed items may be used, and only one item in the list may be needed. For example, “one or more of: A, B, of C” includes any of the following combinations: A, B, C, A and B, A and C, B and C, and A and B and C.

Moreover, multiple functions described below may be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data may be permanently stored and media where data may be stored and later overwritten, such as a rewritable optical disc or an erasable memory device.

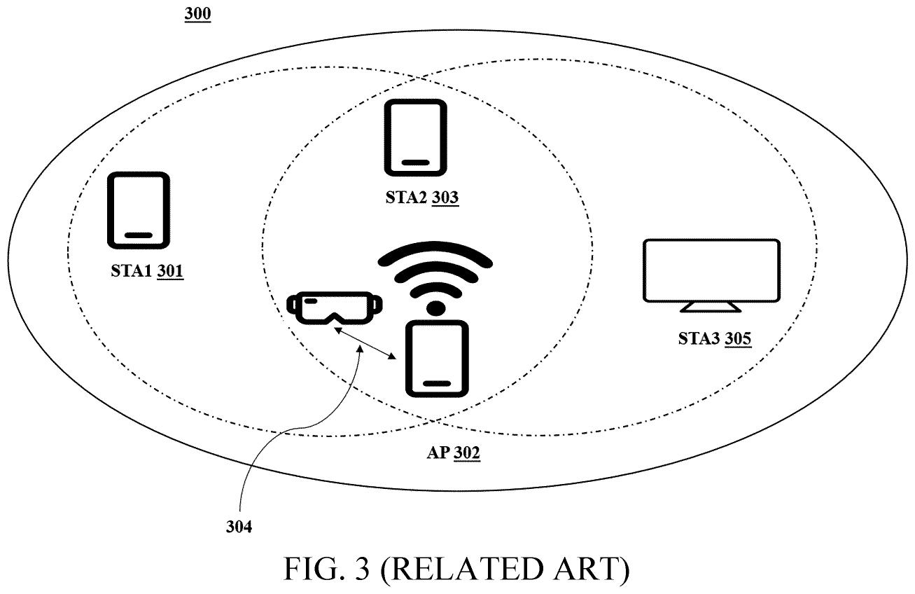

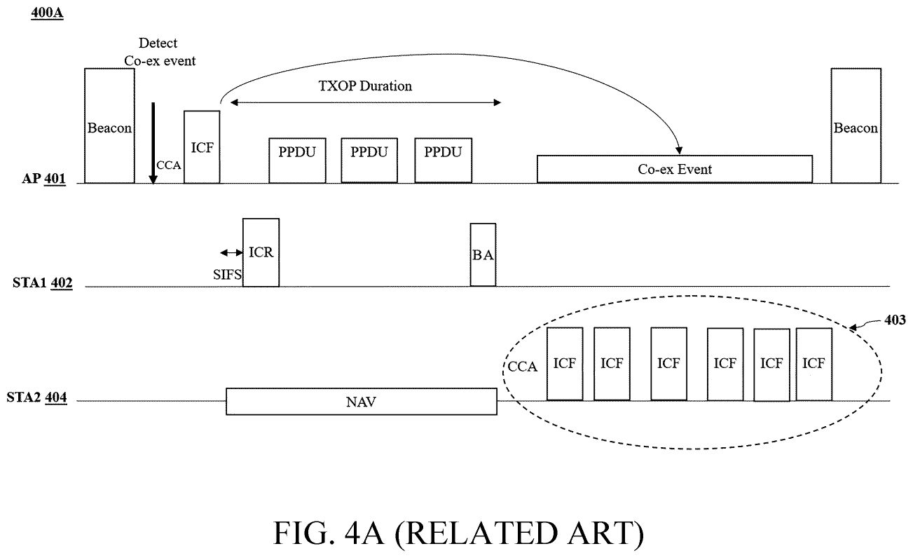

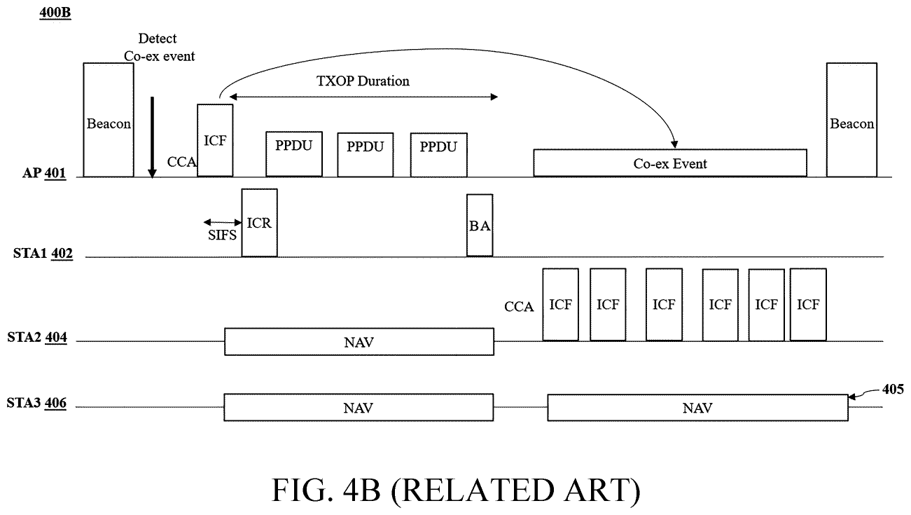

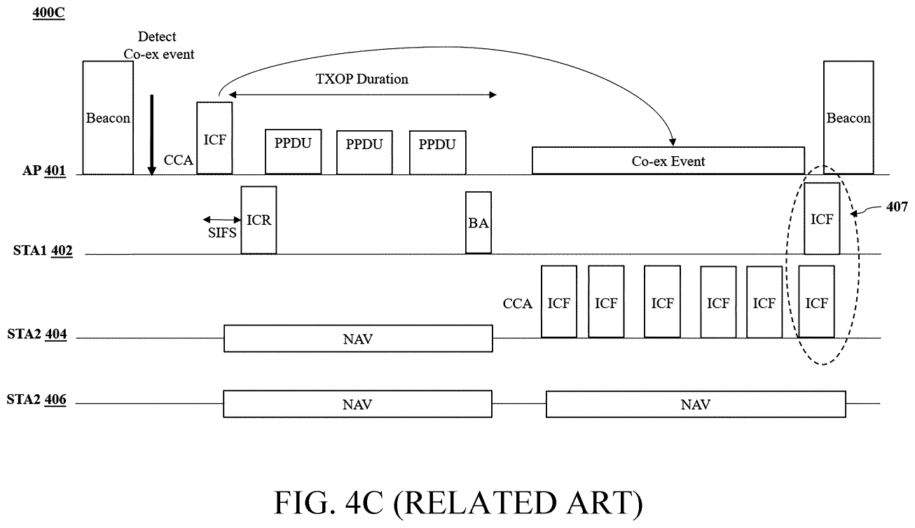

In wireless communication, an in-device co-existence event (also referred to as a co-ex event) refers to an interaction of multiple wireless technologies operating in the same frequency band, which can lead to interference and reduced performance. These co-ex events are common in shared spectrum environments, such as the 2.4 GHz band used by Wi-Fi, Bluetooth, and other devices. The co-ex events lead to various problems, as discussed in reference to FIGS. 3-4C.

FIG. 3 illustrates a Basic Service Set (BSS) environment 300 depicting the co-ex event, in accordance with related art. As shown, the environment 300 comprises an Access Point (AP) 302 and three associated stations (STAs), e.g., STA1 301, STA2 303, and STA3 305. The AP 302, which may be either mobile or non-mobile, is configured to support multiple wireless communication technologies beyond standard Wi-Fi, such as Bluetooth, UWB, NR/5G, or Zigbee. These additional radios can introduce co-existence challenges when their transmission or reception overlaps temporally or spectrally with Wi-Fi operations. As shown in FIG. 3, STA1 301 and STA2 303 are situated in such a manner that they are hidden from each other; e.g., their transmissions cannot be directly detected by one another due to physical separation, attenuation, or other environmental constraints. This hidden-node condition exacerbates the impact of co-ex event 304 occurring at the AP 302, as information regarding AP availability may not be uniformly disseminated among all STAs, e.g., STA1 301, STA2 303, and STA3 305. Consequently, when the AP 302 is engaged in a co-ex event, only a subset of STAs (e.g., STA1 301) may be notified or capable of adapting their behavior accordingly, while other STAs (e.g., STA2 303 and STA3 305) may remain unaware. Hence, there is a lack of synchronization across STAs, e.g., STA1 301, STA2 303, and STA3 305 within the same BSS, leading to degraded system performance during co-ex events, increased latency, unnecessary retransmissions, and inefficient spectrum utilization.

FIG. 4A illustrates a scenario 400A depicting an overhead problem in the co-ex event, in accordance with related art. As shown, an AP 401 detects an urgent or aperiodic co-ex event and proceeds to schedule data transmission with STA1 402. Prior to the data exchange, the AP 401 sends an Initial Control Frame (ICF) to STA1 402, including metadata about the co-ex event, such as its expected start time, duration, and possibly frequency or spatial stream restrictions. This enables STA1 402 to align its Transmit Opportunity (TXOP) scheduling and communication window appropriately. Meanwhile, STA2 402, another STA in the same BSS, remains uninformed about the ongoing co-ex event, as the ICF was not addressed to STA2 402. Upon gaining channel access after the expiration of its Network Allocation Vector (NAV), STA2 402 attempts to initiate its data exchange by sending an ICF to the AP 401. However, due to the co-ex event, the AP 401 does not respond. As per retransmission rules, STA2 402 continues to resend the ICF in an attempt to gain contention-free medium access. These retransmissions not only result in inefficient use of the wireless medium but also increase STA2's power consumption and processing overhead 403, ultimately degrading system efficiency and user experience.

FIG. 4B illustrates a scenario 400B depicting a medium blocked problem in the co-ex event, in accordance with related art. As shown, STA3 406 is also part of the BSS managed by the AP 401. STA3 406 initially sets its NAV based on the ICF exchange between the AP 401 and another STA (e.g., STA1 402 or STA2 404), even though STA3 406 is not a direct participant in that transaction. When STA2 404, unaware of the co-ex event, begins retransmitting ICFs, neighboring STAs that can hear STA2 404, including STA3 406, continually update or extend their NAVs based on Enhanced Distributed Channel Access (EDCA) rules. This repeated NAV reset effectively blocks STA3 406 from accessing the medium for an extended period (indicated by 405), even after the AP's co-ex event has ended and the medium is technically available. As a result, STA3 406 experiences increased latency in initiating or continuing its communication with the AP 401, and such indirect blocking behavior introduces further inefficiencies in overall network performance.

FIG. 4C illustrates a scenario 400C depicting a collision problem in the co-ex event, in accordance with related art. As shown, STA1 402 is informed about the co-ex event and defers its transmission until the co-ex event concludes. Meanwhile, STA2 404, still unaware of the co-ex event, has been continuously retransmitting ICFs during the co-ex event window. Upon the co-ex event's conclusion, both STA1 402 and STA2 404 may attempt to access the medium simultaneously. Since SAT1 402 and STA2 404 are hidden from each other, these STAs are unable to detect mutual transmissions, leading to a potential collision (indicated by 407). This collision results in wasted airtime, increased backoff intervals, and additional retransmission attempts, thereby compounding latency and reducing the effective throughput.

Accordingly, the present disclosure provides techniques to handle the in-device co-existence events to ensure that all the STAs in the BSS are informed about the predicted co-ex events.

Embodiments of the present disclosure will be described below in detail with reference to the accompanying drawings.

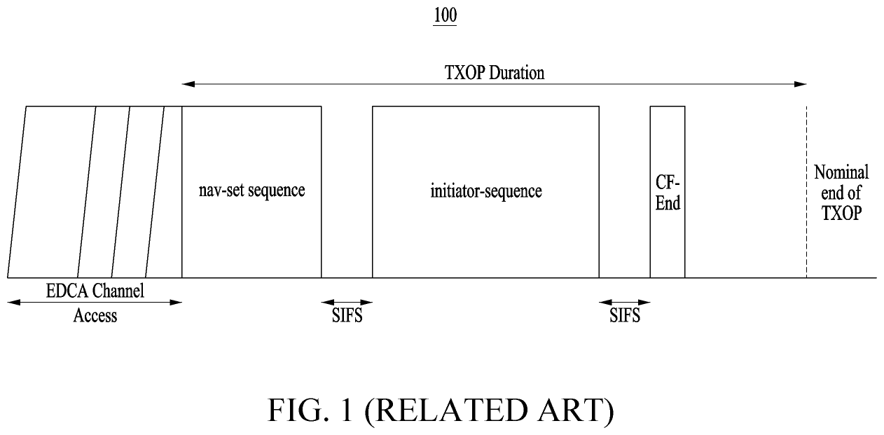

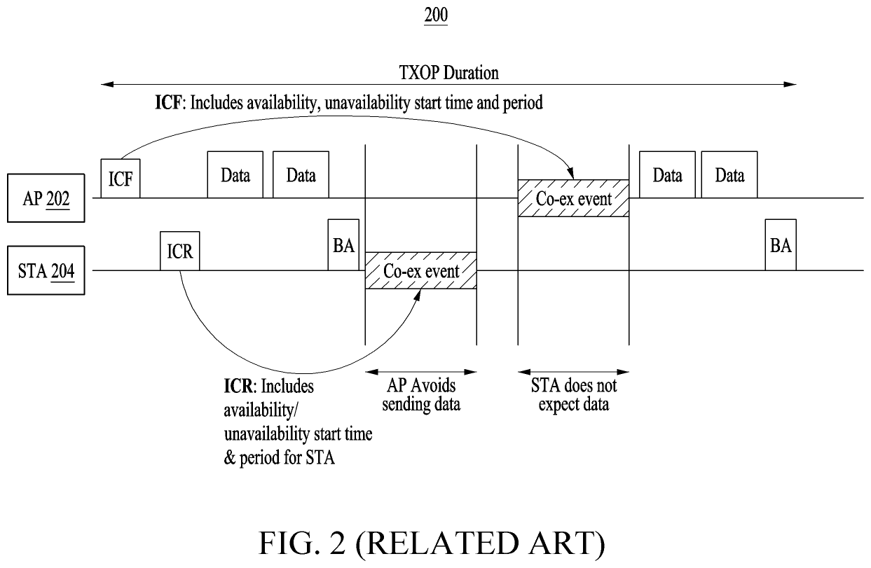

For the sake of clarity, the first digit of a reference numeral of each component of the present disclosure is indicative of the Figure number, in which the corresponding component is shown. For example, reference numerals starting with digit “1” are shown at least in FIG. 1. Similarly, reference numerals starting with digit “2” are shown at least in FIG. 2. Further, similar reference numerals have been used to represent similar components in the Figures.

It should be noted that the terms “co-existence” and “co-ex” have been used interchangeably throughout the specification and drawings.

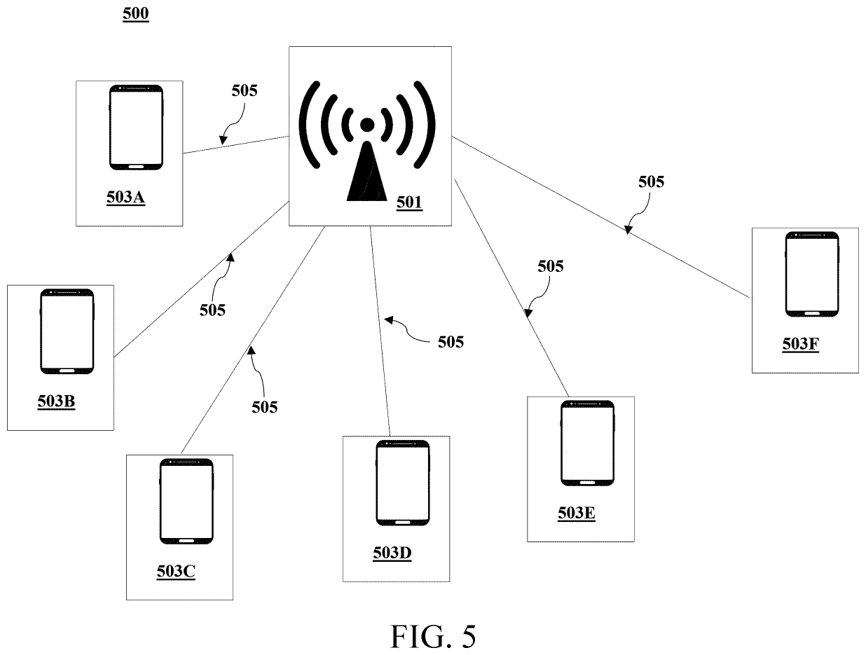

FIG. 5 illustrates an exemplary wireless communication network 500, in accordance with an example embodiment. In an embodiment, the wireless communication network 500 may include an Access Point (AP) 501 connected, directly or indirectly, to a plurality of STAs 503A-503F (also referred to as the STAs 503). The AP 501 may serve as a central wireless node that facilitates network connectivity by bridging the user device 503 with a wired or core network infrastructure (not shown). The AP 501 may include, but is not limited to, transceivers, antennas, processing circuitry, a mobile AP, and software logic to manage wireless traffic, authenticate users, and allocate radio resources.

The STAs 503 may be any wireless-enabled terminals or nodes. The STAs 503 may be dispersed throughout the coverage area of the wireless communication network 500, and each of the STAs 503 may be stationary, mobile, or both at different times. The STAs 503 may be devices in different forms or have different capabilities.

Further, the STAs 503 may include or may be referred to as a Station (STA), a wireless device, a remote device, a handheld device, a subscriber device, or some other suitable terminology, where the “device” may also be referred to as a unit, a station, a terminal, or a client, among other examples. The STAs 503 may also include or may be referred to as a personal electronic device, such as a cellular phone, a Personal Digital Assistant (PDA), a tablet computer, a laptop computer, or a personal computer. In some examples, the STAs 503 may include or be referred to as a Wireless Local Loop (WLL) station, an Internet of Things (IoT) device, an Internet of Everything (IoE) device, or a Machine-Type Communications (MTC) device, among other examples, which may be implemented in various objects such as appliances, or vehicles, meters, among other examples. Further, each of the STAs 503 may be capable of establishing a wireless connection with the serving AP 501 via one or more communication links 505.

The one or more communication links 505 may represent active wireless communication paths established between the serving AP 501 and the STAs 503. The one or more communication links 505 may operate according to one or more wireless communication standards, such as IEEE 802.11 (e.g., 802.11n, 802.11ac, 802.11ax, 802.11be, 802.11bn). The one or more communication links 505 may support various data rates, frequency bands, and modulation schemes. The one or more communication links 505 may facilitate bidirectional transmission of data packets, management frames, and control signals. In some embodiments, each of the one or more communication links 505 may be dynamically adapted based on signal quality, network congestion, or device capabilities to optimize performance and maintain connectivity.

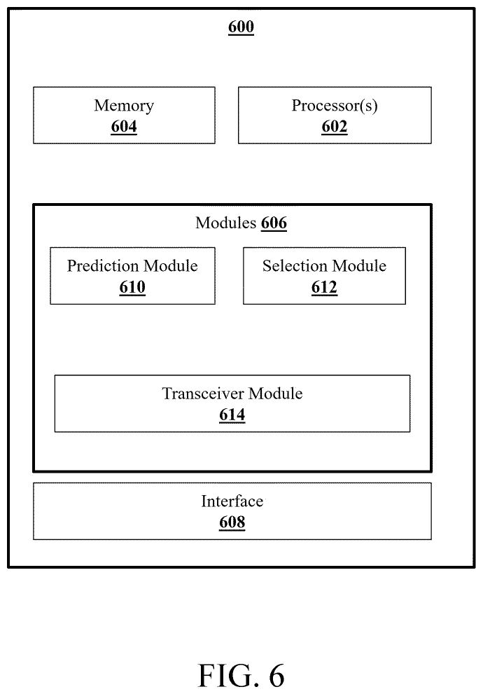

FIG. 6 illustrates a block diagram of a system 600 for managing the co-existence event in the wireless communication network 500, in accordance with an example embodiment. In an embodiment, the system 600 may correspond to the AP 501. FIG. 6 has been explained in conjunction with FIG. 5 for the sake of brevity of the disclosure.

The system 600 may include one or more processors 602 (hereinafter referred to as the processor 602), a memory 604, modules 606, and an interface 608 comprising interface circuitry. In an exemplary embodiment, the one or more processors 602 may be operatively coupled, directly or indirectly, to the memory 604, the modules 606, and the interface 608. Each “module” and “unit” herein may comprise circuitry.

In an embodiment, the processor 602, comprising processing circuitry, may include at least one data processor for executing processes in a Virtual Storage Area Network. The processor 602 may include specialized processing units such as integrated system (bus) controllers, memory management control units, floating point units, graphics processing units, digital signal processing units, etc. In an embodiment, the processor 602 may include a Central Processing Unit (CPU), a Graphics Processing Unit (GPU), or both. The processor 602 may be one or more general processors, Digital Signal Processors (DSPs), application-specific integrated circuits, Field-Programmable Gate Arrays (FPGAs), servers, networks, digital circuits, analog circuits, combinations thereof, or other now-known or later developed devices for analyzing and processing data. The processor 602 may execute a software program, such as code generated manually (e.g., programmed) to perform the desired operation. The processor 602 may implement various techniques, such as, but not limited to, image processing, data extraction, Artificial Intelligence (AI), Machine Learning (ML), Deep Learning (DL), and so forth, to achieve the desired objective.

In an embodiment, the processor 602 may be configured to perform the functions of the system 600 or the AP 501.

The processor 602 may be disposed in communication with one or more Input/Output (I/O) devices, such as the STAs 503, via the interface 608. The interface 608 may employ communication Code-Division Multiple Access (CDMA), High-Speed Packet Access (HSPA+), Global System For Mobile Communications (GSM), Long-Term Evolution (LTE), WiMax, Wi-Fi, or the like, etc. Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 602 can include processing circuitry, which can be implemented by a circuit, for example a system on chip (SoC) or an integrated circuit (IC). The processor 602 may include the combination of one or more processors such as a CPU, GPU, MPU, an application processor (AP), and a communication processor (CP).

In an embodiment, the processor 602 may be disposed in communication with a communication network via a network interface. In an embodiment, the network interface may be the interface 608. The network interface may connect to the communication network to enable connection of the system 600 with the outside environment and/or device/system. The network interface may employ connection protocols, including, without limitation, direct connect, Ethernet (e.g., twisted pair 10/100/1000 Base T), Transmission Control Protocol/Internet Protocol (TCP/IP), token ring, IEEE 802.11/b/g/n/x, etc. The communication network may include, without limitation, a direct interconnection, Local Area Network (LAN), Wide Area Network (WAN), wireless network (e.g., using Wireless Application Protocol (WAP), the Internet, etc. Using the network interface and the communication network, the system 600 may communicate with other devices. The network interface may employ connection protocols including, but not limited to, direct connect, Ethernet (e.g., twisted pair 10/100/1000 Base T), TCP/IP, token ring, IEEE 802.11/b/g/n/x, etc.

The memory 604 may be communicatively coupled, directly or indirectly, to the processor 602. The memory 604 may be configured to store data and instructions executable by the processor 602. In an embodiment, the memory 604 may communicate via a bus within the system 600. The memory 604 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 604 may include a cache or random-access memory for the processor 602. In alternative examples, the memory 604 is separate from the processor 602, such as a cache memory of a processor, the system memory, or other memory. The memory 604 may be an external storage device or database for storing data. The memory 604 may be operable to store instructions executable by the processor 602. The functions, acts, or tasks illustrated in the figures or described may be performed by the programmed processor 602 for executing the instructions stored in the memory 604. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like. The memory 604 may further include a database to store the data. Further, the memory 604 may include an operating system for performing one or more tasks of the system 600, as performed by a generic operating system in the communications domain. The memory 604 stores instructions that, when executed by at least one processor individually or collectively, cause the system 600, which can be an AP, to perform the methods and/or the operations described herein. The at least one processor may include the combination of one or more processors such as the processor 602, the processing circuitry in the prediction module 610, the processing circuitry in the selection module 612, the processing circuitry in the transceiver module 614, a CPU, GPU, MPU, an application processor (AP), and a communication processor (CP). The processing circuitry in the prediction module 610 may be included in the processor 602. The processing circuitry in the selection module 612 may be included in the processor 602. The processing circuitry in the transceiver module 614 may be included in the processor 602.

For the sake of brevity, the architecture and standard operations of the processor 602 and the memory 604 are not discussed in detail. In an embodiment, the memory 604 may be configured to store the information as required by the processor 602 to perform the techniques described herein.

The modules 606, amongst other things, include routines, programs, objects, components, data structures, etc., which perform particular tasks or implement data types. The modules 606 may also be implemented as signal processor(s), state machine(s), logic circuits, and/or any other device or component that manipulates signals based on operational instructions. The modules 606 may be configured to one or more operations of the system 600 and/or the processor 602.

Further, the modules 606 can be implemented in hardware, instructions executed by a processing unit, or by a combination thereof. The processing unit can comprise a computer, the processor 602, a state machine, a logic array, or any other suitable device capable of processing instructions. The processing unit can be a general-purpose processor that executes instructions to cause the general-purpose processor to perform the required tasks, or the processing unit can be dedicated to performing the required functions. In another example embodiment, the modules 606 may be machine-readable instructions (software) that, when executed by a processor/processing unit, perform any of the described functionalities. Furthermore, the data serves, amongst other things, as a repository for storing data processed, received, and generated by one or more of the modules. The modules 606 may include a prediction module 610, a selection module 612, and a transceiver module 614. Each such module may include processing circuitry, which can be implemented by a circuit, for example a system on chip (SoC) or an integrated circuit (IC). Each such module can be controlled by the processor(s) 602.

In an embodiment, the prediction module 610 may be configured to predict an occurrence of the co-existence event at the AP 501 of the wireless communication network 500. In an embodiment, the prediction module 610 may be configured to predict the occurrence of the co-existence event within or after a predefined threshold time interval. The predefined threshold time interval may be user-configured or pre-configured. In an embodiment, the co-existence event may correspond to a period during which the AP 501 is expected to be unavailable for wireless communication. The prediction module 610 may predict the occurrence of the co-existence event in accordance with techniques known to a person skilled in the art. For example, the prediction module 610 may predict the occurrence of the co-existence event by monitoring internal events, algorithms, and technology module (e.g., Bluetooth, NR, UWB, etc.) interrupts. In another example, the prediction module 610 may predict the occurrence of the co-existence event using predictive models, such as machine learning algorithms trained on historical data logs, which can also be used to forecast future co-ex events. These predictive models consider patterns in device activity, error rates, and signal conditions.

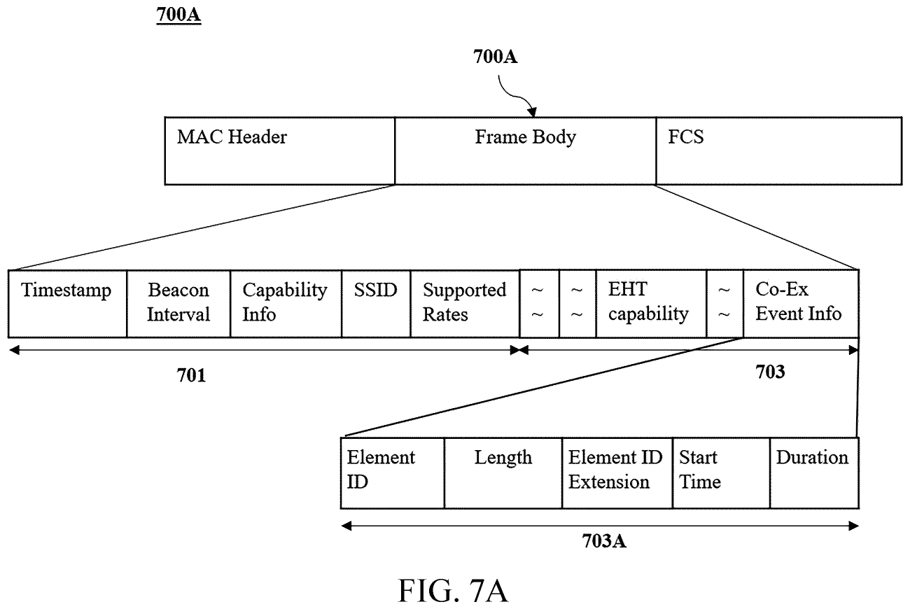

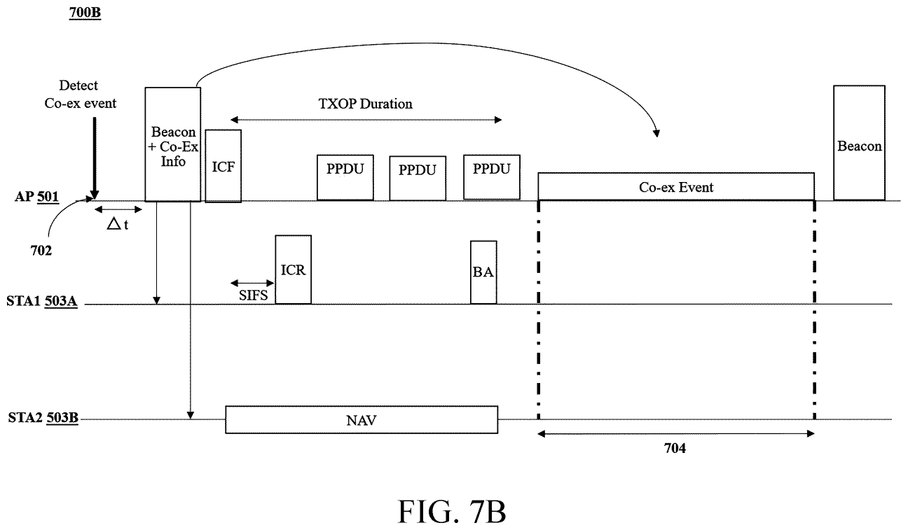

Then, the selection module 612 may be configured to select a signaling mechanism/technique from among a plurality of predefined signaling mechanisms for transmitting a co-existence information associated with the co-existence event. The selection module 612 may be configured to select the signaling mechanism based on the prediction. In an embodiment, the plurality of predefined signaling mechanisms may include, but are not limited to, inserting the co-existence information into a field of a beacon frame, broadcasting the co-existence information in a broadcast message, transmitting a multi-user broadcast (MU-BCS) frame including the co-existence information during transmission opportunity (TXOP) held by the AP, transmitting a release with information (RWI) frame indicating the end of the TXOP and a predefined information followed by the MU-BCS frame, and embedding the co-existence information in an initial control frame. The plurality of predefined signaling mechanisms and the selection of the signaling mechanism have been further explained in reference to FIGS. 7A-14. In an embodiment, the co-existence information may include, but is not limited to, a start time and a duration of the co-existence event. Further, in an embodiment, the co-existence information may comprise a service set identifier (SSID) identifying a basic service set (BSS) of the AP 501.

Then, the transceiver module 614, comprising transceiving circuitry, may be configured to transmit the co-existence information to STAs associated with the AP 501, such as the STAs 503, using the selected transmission mechanism.

FIG. 7A illustrates the beacon frame 700A with the co-existence information, in accordance with an example embodiment. FIG. 7B illustrates a message sequence 700B of the beacon frame 700A with the co-existence information, in accordance with an example embodiment. FIGS. 7A and 7B have been explained in conjunction with each other for the sake of brevity of the disclosure. In an embodiment, the prediction module 610 may predict the occurrence of the co-existence event within the predefined threshold time interval. The predefined threshold time interval may be associated with a scheduled transmission of the beacon frame 700A. For example, in FIG. 7B, the predefined threshold time interval is represented by Δt. It can be noticed from FIG. 7B, the beacon frame 700A is scheduled to be transmitted after the expiry of Δt. The prediction module 610 may predict the co-existence event may be predicted at time 702, e.g., within Δt. Accordingly, the selection module 612 may select the predefined signaling mechanism as inserting the co-existence information into a field of the beacon frame 700A. As shown in FIG. 7A, the beacon frame 700A may consist of or include mandatory field 701 and optional field 703. The optional field 703 may include an additional field, e.g., co-existence (co-ex) information. In an embodiment, the co-existence information (info) may be defined as shown in Table 1.

TABLE 1

| Order | Information | Notes |
|---|---|---|
| Last-n | co-ex event Info | The co-ex event info is optionally |
| | | present in a beacon. This can be present |
| | | if the dot11coex_event_info is supported |
| | | and set to TRUE. |

In an embodiment, the co-existence information field may be defined by a predefined element identifier (ID). In another embodiment, the co-existence information field may also be defined by an element ID extension. The predefined element ID/element ID extension may be defined as per the available number in the specification development. The co-existence information field may also include a start time, a duration, and a length field. The length field indicates the total length of the co-ex information present following the Element ID extension. The start time may be defined as the start time at which the co-ex event is expected. The duration may be defined as the duration for which the co-ex event is going to last.

Accordingly, the beacon frames are used to broadcast unavailability information to all the STAs, such as STA1 503A and STA2 503B, within the BSS of the AP 501. Hence, the STAs that are not actively communicating with the AP 501 during the co-existence event may conserve power during the unavailability period 704. Additionally, by informing all STAs about the co-ex event, potential issues such as overhead, medium access conflicts, or collisions can be effectively avoided.

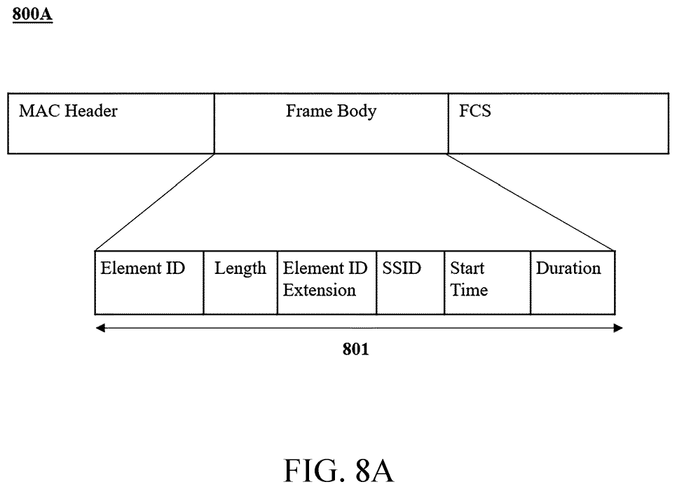

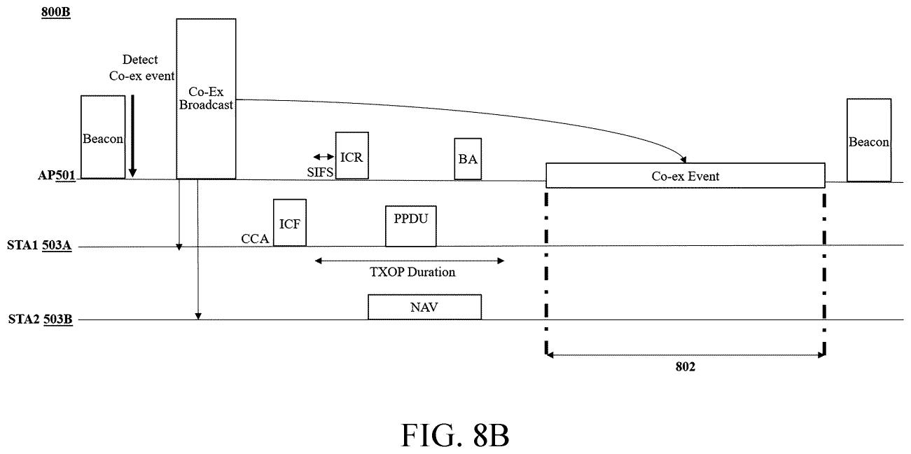

FIG. 8A illustrates the broadcast message 800A with the co-existence information, in accordance with an example embodiment. FIG. 8B illustrates a message sequence 800B of the broadcast message 800A with the co-existence information, in accordance with an example embodiment. FIGS. 8A and 8B have been explained in conjunction with each other for the sake of brevity of the disclosure. In an embodiment, the prediction module 610 may predict the occurrence of the co-existence event after the predefined threshold time interval. The predefined threshold time interval may be associated with a scheduled transmission of the beacon frame. For example, the prediction module 610 may predict the occurrence of the co-existence event after the transmission of the beacon frame. Accordingly, the selection module 612 may select the predefined signaling mechanism as broadcasting the co-existence information in the broadcast message 800A. As shown in FIG. 8A, the co-existence information may be included in a frame body of the broadcast message 800A. In an embodiment, the broadcast message 800A may include co-existence information and a service set identifier (SSID). In an embodiment, the co-ex event info field may be defined by a predefined element identifier (ID). The broadcast message 800A may also include a new element ID/extension ID combination, a start time, a length, and a duration field. The start time may indicate the start time slot from which the co-existence event is expected to begin. The duration may indicate the duration for which the co-existence event is going to last. Further, in an embodiment, the prediction module 610 may also predict an idle period to broadcast the broadcast message 800A. Accordingly, the transceiver module 614 may transmit the broadcast message 800A during the predicted idle period.

Accordingly, the broadcast message 800A can be used to inform all the STAs, such as STA1 503A, STA2 503B, within the BSS of the AP 501 about the impending co-ex event. The STA1 503A, which is aware of the impending co-ex event, can exchange data with the AP 501 in time periods before or after the co-ex event. Further, the broadcast message 800A can help other STAs to manage their TXOP to not clash with the co-ex-time period. Hence, the STAs that are not actively communicating with the AP 501 during the co-existence event may conserve power during the unavailability period 802. Additionally, by informing all STAs about the co-ex event, potential issues such as overhead, medium access conflicts, or collisions can be effectively avoided.

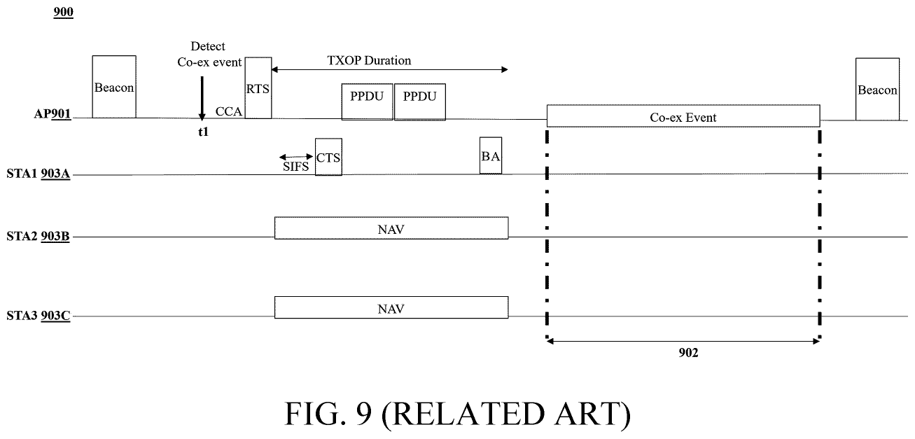

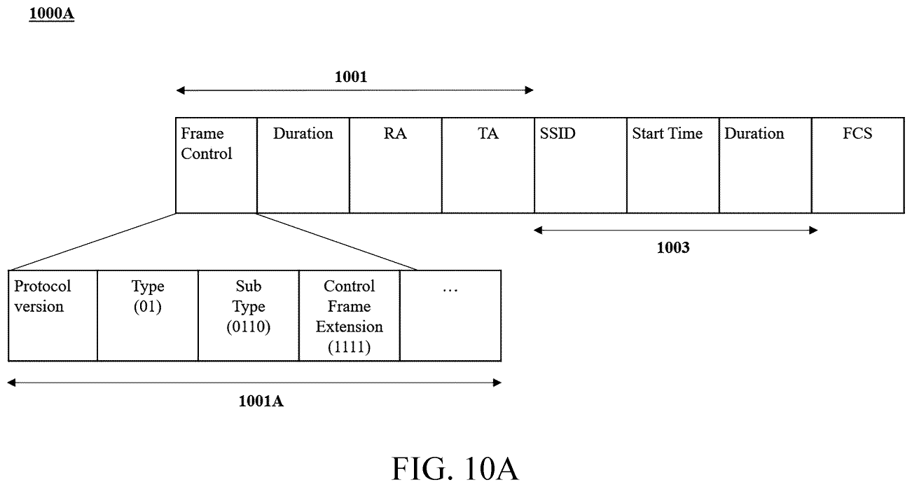

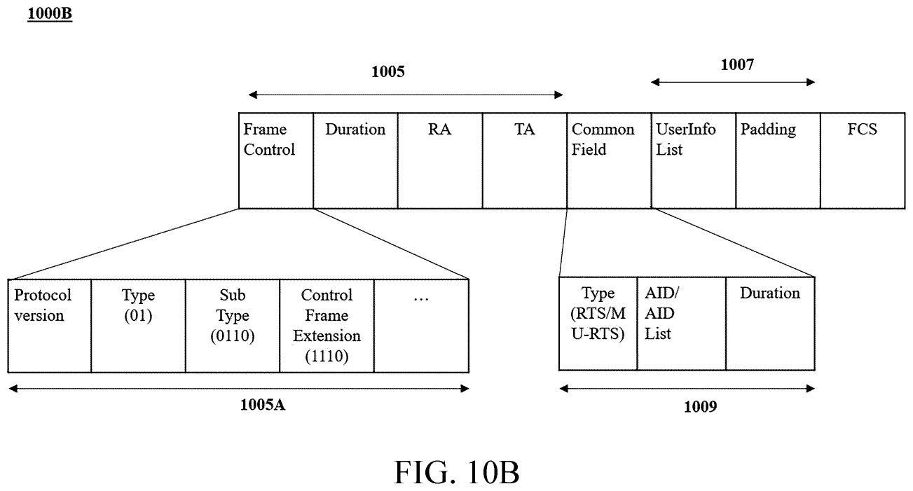

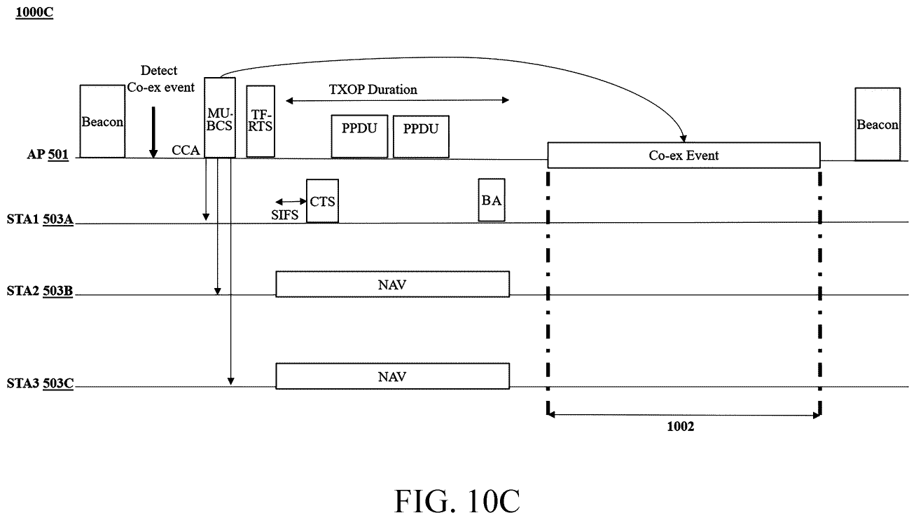

FIG. 9 illustrates a scenario 900 depicting the co-existence event when the STA is a TXOP holder, in accordance with related art. As shown, the co-existence event is detected by the AP 901 at instance t1. However, the AP 901 also decides to get access to the medium through Clear Channel Assessment (CCA) to transmit some data to one of the STAs, e.g., STA1 903A, STA2 903B, and STA3 903C. However, there is no opportunity to send the co-existence information as discussed in reference to FIGS. 7A-8B, as the AP 901 immediately needs to get a TXOP. In such a scenario, the co-existence information can be transmitted in the MU-BCS frame to save power during the co-existence period 902, as discussed in reference to FIGS. 10A-10C.

FIG. 10A illustrates the MU-BCS frame 1000A with the co-existence information, in accordance with an example embodiment. In an embodiment, the prediction module 610 may predict the occurrence of the co-existence event after the completion of the predefined threshold time interval. The predefined threshold time interval may be associated with a TXOP duration. Accordingly, the selection module 612 may select the predefined signaling mechanism as transmitting the MU-BCS frame 1000A including the co-existence information with SSID, during a TXOP acquired by the AP 501. As shown in FIG. 10A, the MU-BCS frame 1000A may include a Medium Access Control (MAC) header 1001 and the co-existence information 1003. The MAC header 1001 may include a control frame 1001A. The control frame 1001A may include a control frame extension field set to a defined value from a plurality of reserved values indicating the co-existence information. In an example, the plurality of reserved values may be 1111. The control frame 1001A may also include a protocol version, a type (01), and a subtype (0110). Further, a Receiver Address (RA) field may be set to a broadcast address. The purpose of the MU-BCS frame 1000A is to inform all the STAs 503 in the BSS of the AP 501 that a co-existence event is predicted, and the related information will be sent via a broadcast message through the contended medium that the AP 501 has gained access to. The control frame format may use the reserved field in the control frame extension field. When the STA receives this control frame, the STA shall ignore the duration field as the STA is expecting a broadcast message. Legacy STA can still set its NAV using the duration field. The RA address for the MU-BCS frame 1000A may be set to a broadcast address so that all the STAs 503 shall receive and process the MU-BCS frame 1000A. Following the MAC header 1001, the co-existence information 1003 is set, which may include the SSID, the start time, and the duration.

FIG. 10B illustrates a trigger frame-request to send (TF-RTS) frame 1000B with the co-existence information, in accordance with an example embodiment. In an embodiment, the transceiver module 614 may transmit the TF-RTS frame 1000B after the transmission of the MU-BCS frame 1000A. The TF-RTS frame 1000B may include an MAC header 1005. The MAC header 1005 may include a control frame 1005A. The control frame 1005A may include a control frame extension field set to a defined value from a plurality of reserved values indicating data transmission. In an embodiment, the plurality of reserved values may be 1110. The control frame 1005 may also indicate a type of TF-RTS frame 1000B. The control frame 1005A may also include a protocol version, a type (01), and a subtype (0110). Further, a RA of the TF-RTS frame 1000B may be set to a broadcast address following the MU-BCS frame 1000A. Accordingly, the AP 501 can send the TF-RTS frame 1000B to start data transfers to the intended STA.

Further, the TF-RTS frame 1000B may include the common field 1009. The common field may include a type of field, e.g., a 2-bit indicator that can identify whether the frame is an RTS type or MU-RTS type, or other ICF. The common field may also include an Association Identifier (AID) list. The AID list may indicate a single AID when only one STA is going to be scheduled, or all those STAs for which data is going to be scheduled. The AID list may also include association identifiers of all the STAs that need to respond to the TF-RTS frame 1000B. When RTS is the type, then a single AID is sent, otherwise, the AID list is sent. Further, the common field may include a duration that can be optionally sent to allow the remaining STAs who are not addressed in the RTS/MU-RTS request to set their NAV duration now. The remaining fields 1007 of the TF-RTS frame 1000B may indicate user info list can set the RTS or MU-RTS related fields per legacy specifications.

FIG. 10C illustrates a message sequence 1000C of the MU-BCS frame 1000A and the TF-RTS frame 1000B, in accordance with an example embodiment. As shown, the AP 501 predicts the co-existence event after beacon transmission. At the same time, the AP 501 also needs to send some data to STA1 503A. The AP 501 gets access to the medium and decides to send the MU-BCS frame 1000A to all the STAs 503 in the BSS. When the STAs, such as STAs 503A, 503B, and 503C, receive the MU-BCS frame 1000A, the said STAs may not set the NAV immediately but may save the future co-existence event in the AP 501.

In an embodiment, after transmitting the MU-BCS frame 1000A, the AP 501 may transmit the TF-RTS frame 1000B because the TF-RTS frame 1000B contains data to send to the STA1 503A. Using the duration information in the TF-RTS common field 1009, all other STAs (like STA2 503B and STA3 503C) whose AID does not match the AID in the TF-RTS frame 1000B may set their NAV. The co-existence information is now available to all the STAs, e.g., STAs 503A, 503B, and 503C, in the BSS of the AP 501.

Accordingly, the AP 501 can utilize the medium to send the co-existence information to all the STAs in its BSS. Further, the disclosed techniques provide a mechanism to set the NAV at other STAs after receiving the co-existence information. Hence, the STAs that are not actively communicating with the AP 501 during the co-existence event may conserve power during the unavailability period 1002. Additionally, by informing all STAs about the co-ex event, potential issues such as overhead, medium access conflicts, or collisions can be effectively avoided.

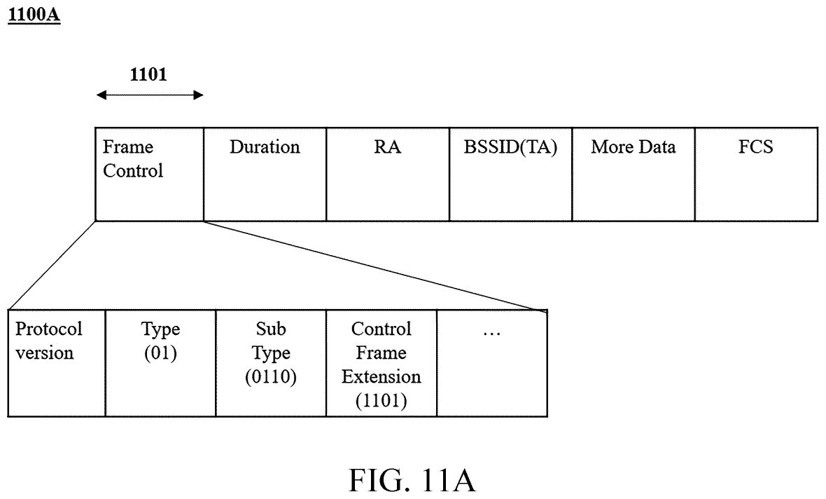

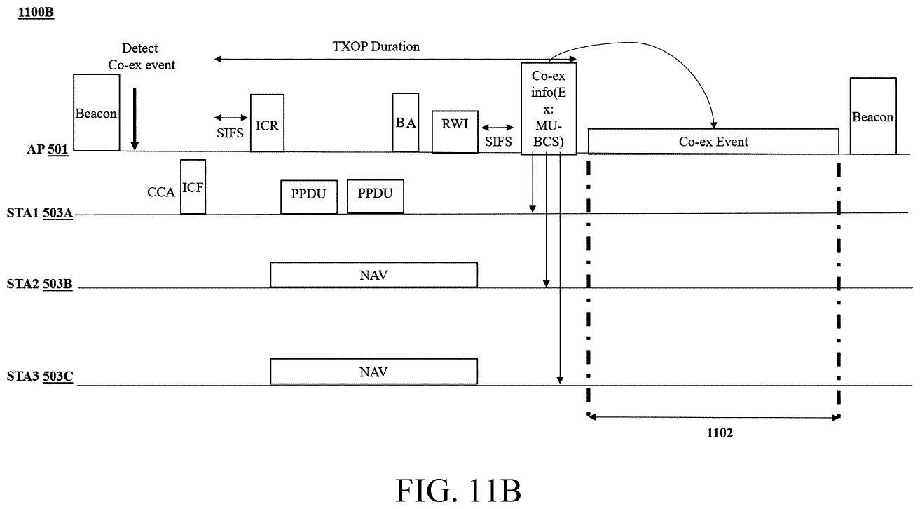

FIG. 11A illustrates the RWI frame 1100A, in accordance with an example embodiment. In an embodiment, the prediction module 610 may predict the occurrence of the co-existence event after the completion of the predefined threshold time interval. The predefined threshold time interval may be associated with the TXOP duration. Accordingly, the selection module 612 may select the predefined signaling mechanism as transmitting the RWI frame 1100A indicating the end of the TXOP and the predefined information, followed by the MU-BCS frame 1000A. As shown in FIG. 11A, the RWI frame 1100A may include a control frame 1101 with an extension field set to a defined value from a plurality of reserved values. In an example, the plurality of reserved values may be 1100. The control frame extension field may also indicate transmission of the MU-BCS frame 1000A including the co-existence information. Further, a Receiver Address (RA) field may be set to a broadcast address. The control frame 1101 may also include a protocol version, a type (01), and a subtype (0110). Further, in an embodiment, the predefined information may indicate transmission of a broadcast message comprising the co-existence information, such as the broadcast message 800A. Following the RWI frame 1100A, the MU-BCS frame 1000A can be sent. In an embodiment, the transceiver 614 may transmit the broadcast message comprising the co-existence information, such as the broadcast message 800A, after the transmission of the RWI frame 1100A. As shown, the RWI frame 1100A may also include a duration field, which may be set to 0. Further, a data field in the RWI frame 1100A shows that after the next SIFS period, the MU-BCS frame 1000A may be sent. If the more data field is set to 1, the information is sent, otherwise, the more data field is set to 0.

FIG. 11B illustrates a message sequence 1100B of the RWI frame 1100A, in accordance with an example embodiment. The message sequence 1100B may be especially useful when the AP 501 is a TXOP responder rather than a TXOP holder. The AP 501, after sending a Block Ack (BA) message, can send the RWI frame 1100A to indicate the end of the contention period and to inform remaining STAs, such as STA 503B, 503C, to listen to the medium for a broadcast message. Further, after the SIFS period, the MU-BCS frame 1000A can be sent to indicate the co-existence event period and duration. Accordingly, the AP 501 can utilize the end of the TXOP period to signal a broadcast message to all the STAs, e.g., STAs 503A-503C, to inform them about the co-existence event. The RWI frame 1100A is also useful in cases where the STA, such as any one of the STAs 503A-503C, is a TXOP responder rather than a TXOP holder. Hence, the STAs that are not actively communicating with the AP 501 during the co-existence event may conserve power during the unavailability period 1102. Additionally, by informing all STAs about the co-ex event, potential issues such as overhead, medium access conflicts, or collisions can be effectively avoided.

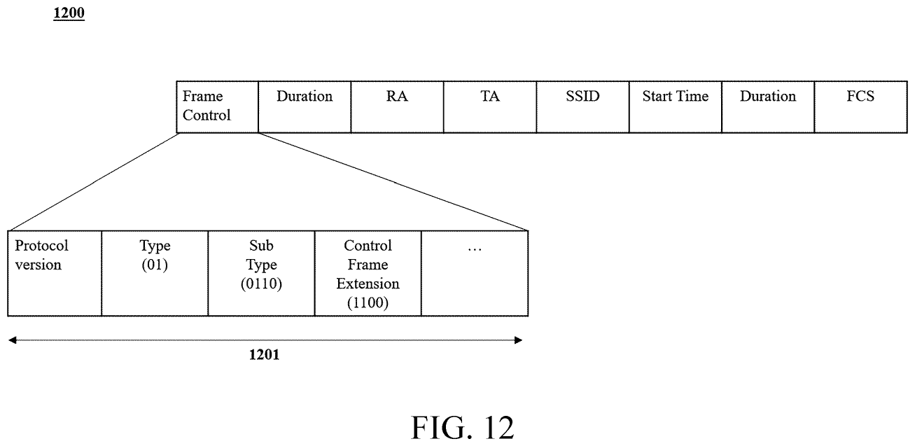

FIG. 12 illustrates the initial control frame 1200, in accordance with an example embodiment. In an embodiment, the prediction module 610 may predict the occurrence of the co-existence event after the completion of the predefined threshold time interval. The predefined threshold time interval may be associated with the TXOP duration. Accordingly, the selection module 612 may select the predefined signaling mechanism as embedding the co-existence information in the initial control frame 1200. In an embodiment, the initial control frame may be one of an Initial Control Frame (ICF) and an Initial Control Response (ICR) frame. As shown in FIG. 12, the ICF frame 1200 that already carries the co-existence event should be processed by all the STAs that receive the ICF/ICR irrespective of the RA address. As shown, a control frame 1201 from reserved bits is used for this purpose. The control frame 1201 may also include a protocol version, a type (01), and a subtype (0110). The control frame 1201 may be defined as shown in Table 2.

TABLE 2

| | Sub Type | Control Frame | |
|---|---|---|---|
| Type Value | Value B7 B6 | Extension Value | |
| B3 B2 | B5 B4 | B11 B10 B9 B9 | Description |
| 01 | 0110 | 1100 | Co-ex ICF |
| 01 | 0110 | 1101 | RWI—Release |
| | | | With Information |
| 01 | 0110 | 1110 | TF-RTS |
| | | | Trigger Frame |
| | | | RTS |
| 01 | 0110 | 1111 | MU-BCS |

When the relevant control frame extension is received, all the STAs shall save the co-existence profile information and not access the medium during that period. Accordingly, the ICF or the ICR is processed in such a way that, irrespective of the RA address, the information that follows, for the co-existence event, is processed. In an embodiment, a MU-RTS may be an example of the ICF frame.

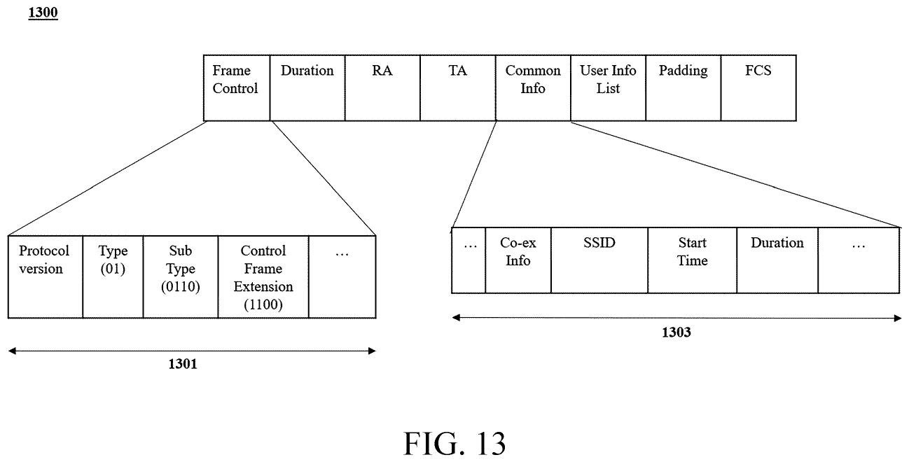

FIG. 13 illustrates the MU-RTS frame 1300, in accordance with an example embodiment. As shown, the MU-RTS frame 1300 may consist of or include a control frame 1301, followed by common info 1303, and a user info list. The common info 1303 can be updated to include the SSID, Co-ex info (control), start time, and duration of the co-existence event. The co-existence info control can be a 1-bit indication to indicate whether co-existence info is present or not. If the co-existence info is present, then the following fields shall indicate the start time and duration of the co-existence event, and SSID can also be present optionally. The control frame 1301 may also include a protocol version, a type (01), a subtype (0110), and a control frame extension field (1100).

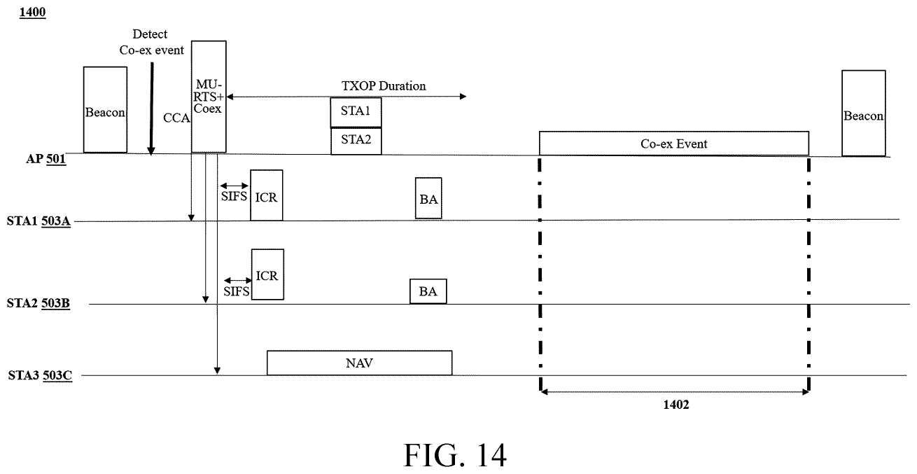

FIG. 14 illustrates a message sequence 1400 of the Initial Control Frame, in accordance with an example embodiment. As shown, the ICF frame 1200/1300 is updated to include the co-existence event. In an exemplary embodiment, the ICF may be a Multi-User RTS frame that carries the co-ex information. The frame's RA is set to the broadcast address, so that all the STAs can receive the co-ex information in the Common fields. The MU-RTS can further address specific STAs to be ready to receive or upload some data frames. Even in such cases, all STAs are informed, as shown in FIG. 14. The same can be extended to an ICR as well. The information within the ICF may be processed using common fields by all the STAs, such as STAs 503A-503C, irrespective of whether the ICF is addressed to that STA. Further, as a result, all the STAs are informed about the co-existence event at the AP 501. Hence, the STAs that are not actively communicating with the AP 501 during the co-existence event may conserve power during the unavailability period 1402. Additionally, by informing all STAs about the co-ex event, potential issues such as overhead, medium access conflicts, or collisions can be effectively avoided.

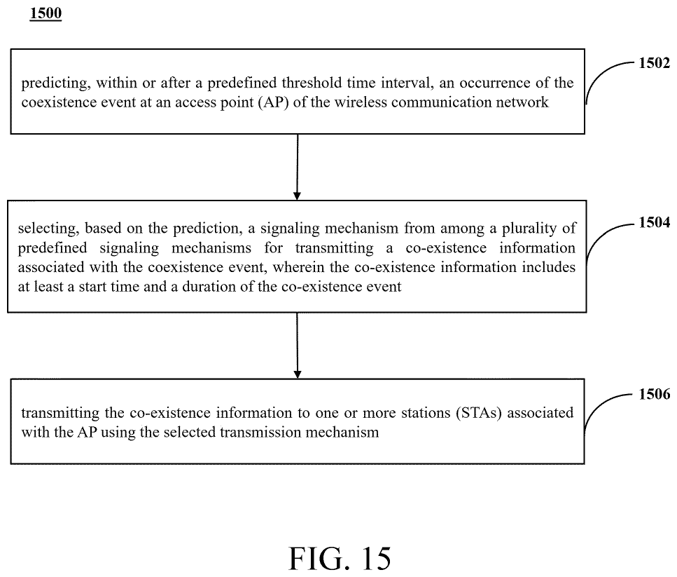

FIG. 15 illustrates a flow diagram depicting a method 1500 for managing the co-existence event in the wireless communication network 500, in accordance with an example embodiment. As shown at operation 1502, the method 1500 may include predicting, within or after the predefined threshold time interval, the occurrence of the co-existence event at the AP 501. At operation 1504, the method 1500 may include selecting, based on the prediction, the signaling mechanism/technique from among the plurality of predefined signaling mechanisms for transmitting the co-existence information associated with the co-existence event. The co-existence information may include, but is not limited to, the start time and the duration of the co-existence event. At operation 1506, the method 1500 may include transmitting the co-existence information to the one or more STAs 503 associated with the AP 501 using the selected transmission mechanism. “Based on” as used herein covers based at least on. Each embodiment herein may be used in combination with any other embodiment(s) described herein.

While the above-discussed steps in FIG. 15 are shown and described in a particular sequence, the steps may occur in variations to the sequence in accordance with various embodiments. Further, a detailed description related to the various steps of FIG. 15 is already covered in the description related to FIGS. 5-14 and is omitted herein for the sake of brevity.

One aspect of the present disclosure provides an access point (AP). The AP comprises at least one processor including processing circuitry. The AP comprises memory storing instructions that, when executed by the at least one processor individually or collectively, cause the AP to predict an occurrence of the co-existence event at the AP. The instructions, when executed by the at least one processor individually or collectively, cause the AP to select, based on the prediction, a signaling technique from among a plurality of signaling techniques for transmitting a co-existence information associated with the co-existence event. The co-existence information includes at least a start time and a duration of the co-existence event. The method comprises transmitting the co-existence information to one or more stations (STAs) associated with the AP using the selected signaling technique.

In an embodiment, the plurality of signaling techniques comprises two or more of: (1) inserting the co-existence information into a field of a beacon frame, (2) broadcasting the co-existence information in a broadcast message, (3) transmitting a Multi-User Broadcast (MU-BCS) frame including the co-existence information during Transmission Opportunity (TXOP) held by the AP, (4) transmitting a Release With Information (RWI) frame indicating the end of the TXOP and a predefined information followed by the MU-BCS frame, and (5) embedding the co-existence information in an initial control frame.

In an embodiment, said transmitting of the co-existence information comprises transmitting the co-existence information at least by inserting the co-existence information into a field of a beacon frame, when the co-existence event is predicted to occur within a predefined threshold time interval. The predefined threshold time interval is associated with a scheduled transmission of the beacon frame.

In an embodiment, the field of the beacon frame is identified by a predefined element Identifier (ID).

In an embodiment, said transmitting of the co-existence information comprises broadcasting a message including the co-existence information and a Service Set Identifier (SSID), when the co-existence event is predicted to occur after a predefined threshold time interval. The predefined threshold time interval is associated with a scheduled transmission of a beacon frame.

In an embodiment, said transmitting of the broadcast message comprises predicting an idle period to broadcast the broadcast message, and transmitting the broadcast message during the predicted idle period.

In an embodiment, said transmitting of the co-existence information comprises transmitting a MU-BCS frame including the co-existence information with SSID during a TXOP acquired by the AP, when the co-existence event is predicted to occur after a completion of a predefined threshold time interval. The predefined threshold time interval is associated with a TXOP duration.

In an embodiment, the MU-BCS frame includes a control frame extension field set to a defined value from a plurality of reserved values indicating the co-existence information and a Receiver Address (RA) field set to a broadcast address.

In an embodiment, the instructions, when executed by the at least one processor individually or collectively, cause the AP to transmit a Trigger Frame-Request To Send (TF-RTS) frame after the transmission of the MU-BCS frame, wherein the TF-RTS frame includes a control frame extension field set to a defined value from a plurality of reserved values indicating data transmission. The control frame extension field indicates a type of the TF-RTS frame, and a Receiver Address (RA) of the TF-RTS frame is set to a broadcast address.

In an embodiment, said transmitting of the co-existence information comprises transmitting an RWI frame indicating the end of a TXOP and the predefined information, when the co-existence event is predicted to occur after a predefined threshold time interval. The predefined threshold time interval is associated with a TXOP duration. The RWI frame includes a control frame extension field set to a defined value from a plurality of reserved values. The control frame extension field indicates transmission of a MU-BCS frame including the co-existence information. A Receiver Address (RA) of the RWI frame is set to a broadcast address.

In an embodiment, the predefined information comprises transmission of a broadcast message comprising the co-existence information.

In an embodiment, the instructions, when executed by the at least one processor individually or collectively, cause the AP to transmit the broadcast message comprising the co-existence information after the transmission of the RWI frame.

In an embodiment, said transmitting of the co-existence information comprises embedding the co-existence information in an initial control frame, when the co-existence event is predicted to occur after a predefined threshold time interval. The predefined threshold time interval is associated with a TXOP duration.

In an embodiment, the initial control frame is one of an Initial Control Frame (ICF) and an Initial Control Response (ICR) frame.

In an embodiment, the initial control frame includes a control frame extension field set to a defined value from a plurality of reserved values indicating the co-existence information.

In an embodiment, the co-existence information further comprises a Service Set Identifier (SSID) Identifying A Basic Service Set (BSS) of the AP.

In an embodiment, the co-existence event corresponds to a period during which the AP is expected to be unavailable for wireless communication.

One aspect of the present disclosure provides an access point (AP). The AP comprises at least one processor including processing circuitry. The AP comprises memory storing instructions that, when executed by the at least one processor individually or collectively, cause the AP to predict an occurrence of the co-existence event at the AP. The instructions, when executed by the at least one processor individually or collectively, cause the AP to insert a co-existence information into a field of a beacon frame. The co-existence information is associated with the co-existence event. The co-existence information includes at least a start time and a duration of the co-existence event. The instructions, when executed by the at least one processor individually or collectively, cause the AP to transmit the co-existence information to one or more stations (STAs) via the beacon frame.

In an embodiment, said transmitting of the co-existence information comprises transmitting the co-existence information by inserting the co-existence information into a field of a beacon frame, when the co-existence event is predicted to occur within a predefined threshold time interval. The predefined threshold time interval is associated with a scheduled transmission of the beacon frame.

In an embodiment, the field of the beacon frame is identified by a predefined element Identifier (ID).

One aspect of the present disclosure provides an access point (AP). The AP comprises at least one processor including processing circuitry. The AP comprises memory storing instructions that, when executed by the at least one processor individually or collectively, cause the AP to predict an occurrence of the co-existence event at the AP. The instructions, when executed by the at least one processor individually or collectively, cause the AP to broadcast a co-existence information in a broadcast message. The co-existence information is associated with the co-existence event. The co-existence information includes at least a start time and a duration of the co-existence event.

In an embodiment, said broadcasting of the co-existence event comprises broadcasting a message including the co-existence information and a Service Set Identifier (SSID) when the co-existence event is predicted to occur after a predefined threshold time interval. The predefined threshold time interval is associated with a scheduled transmission of a beacon frame.

In an embodiment, said broadcasting of the co-existence event comprises predicting an idle period to broadcast the broadcast message, and transmitting the broadcast message during the predicted idle period.

One aspect of the present disclosure provides an access point (AP). The AP comprises at least one processor including processing circuitry. The AP comprises memory storing instructions that, when executed by the at least one processor individually or collectively, cause the AP to predict an occurrence of the co-existence event at the AP. The instructions, when executed by the at least one processor individually or collectively, cause the AP to transmit a Multi-User Broadcast (MU-BCS) frame including a co-existence information during Transmission Opportunity (TXOP) held by the AP. The co-existence information is associated with the co-existence event. The co-existence information includes at least a start time and a duration of the co-existence event.

In an embodiment, said transmitting of the Multi-User Broadcast (MU-BCS) frame comprises transmitting the MU-BCS frame including the co-existence information with SSID during a TXOP acquired by the AP, when the co-existence event is predicted to occur after a completion of a predefined threshold time interval. The predefined threshold time interval is associated with a TXOP duration.

In an embodiment, the MU-BCS frame includes a control frame extension field set to a defined value from a plurality of reserved values indicating the co-existence information and a Receiver Address (RA) field set to a broadcast address.

In an embodiment, the instructions, when executed by the at least one processor individually or collectively, cause the AP to transmit a Trigger Frame-Request To Send (TF-RTS) frame after the transmission of the MU-BCS frame. The TF-RTS frame includes a control frame extension field set to a defined value from a plurality of reserved values indicating data transmission. The control frame extension field indicates a type of the TF-RTS frame. A Receiver Address (RA) of the TF-RTS frame is set to a broadcast address.

One aspect of the present disclosure provides an access point (AP). The AP comprises at least one processor including processing circuitry. The AP comprises memory storing instructions that, when executed by the at least one processor individually or collectively, cause the AP to predict an occurrence of the co-existence event at the AP. The instructions, when executed by the at least one processor individually or collectively, cause the AP to transmit a Release With Information (RWI) frame indicating the end of the TXOP and a predefined information followed by the MU-BCS frame to one or more stations (STAs). The RWI frame includes a control frame extension field set to a defined value from a plurality of reserved values. The control frame extension field indicates transmission of a MU-BCS frame including the co-existence information. The co-existence information is associated with the co-existence event. The co-existence information includes at least a start time and a duration of the co-existence event. A Receiver Address (RA) of the RWI frame is set to a broadcast address.

In an embodiment, the instructions, when executed by the at least one processor individually or collectively, cause the AP to transmit the RWI frame indicating the end of a TXOP and the predefined information, when the co-existence event is predicted to occur after a predefined threshold time interval. The predefined threshold time interval is associated with a TXOP duration.

In an embodiment, the predefined information comprises transmission of a broadcast message comprising the co-existence information.

In an embodiment, the instructions, when executed by the at least one processor individually or collectively, cause the AP to transmit the broadcast message comprising the co-existence information after the transmission of the RWI frame.

One aspect of the present disclosure provides an access point (AP). The AP comprises at least one processor including processing circuitry. The AP comprises memory storing instructions that, when executed by the at least one processor individually or collectively, cause the AP to predict an occurrence of the co-existence event at the AP. The instructions, when executed by the at least one processor individually or collectively, cause the AP to embed a co-existence information in an initial control frame. The co-existence information includes at least a start time and a duration of the co-existence event. The instructions, when executed by the at least one processor individually or collectively, cause the AP to transmit the initial control frame to one or more stations (STAs).

In an embodiment, the embedding of the co-existence information comprises embedding the co-existence information in an initial control frame, when the co-existence event is predicted to occur after a predefined threshold time interval. The predefined threshold time interval is associated with a TXOP duration.

In an embodiment, the initial control frame is one of an Initial Control Frame (ICF) and an Initial Control Response (ICR) frame.

In an embodiment, the initial control frame includes a control frame extension field set to a defined value from a plurality of reserved values indicating the co-existence information.

One aspect of the present disclosure provides a method for wireless communication performed by an access point (AP). The method comprises predicting an occurrence of the co-existence event at the AP. The method comprises selecting, based on the prediction, a signaling technique from a plurality of signaling techniques for transmitting a co-existence information associated with the co-existence event. The co-existence information includes at least a start time and a duration of the co-existence event. The method comprises transmitting the co-existence information to one or more stations (STAs) associated with the AP using via the selected signaling technique.

In an embodiment, the plurality of signaling techniques comprises two or more of: (1) inserting the co-existence information into a field of a beacon frame, (2) broadcasting the co-existence information in a broadcast message, (3) transmitting a Multi-User Broadcast (MU-BCS) frame including the co-existence information during Transmission Opportunity (TXOP) held by the AP, (4) transmitting a Release With Information (RWI) frame indicating the end of the TXOP and a predefined information followed by the MU-BCS frame, and (5) embedding the co-existence information in an initial control frame.

In an embodiment, said transmitting co-existence information comprises inserting the co-existence information into a field of a beacon frame, when the co-existence event is predicted to occur within the predefined threshold time interval. The predefined threshold time interval is associated with a scheduled transmission of the beacon frame.

In an embodiment, the field of the beacon frame is identified by a predefined element Identifier (ID).

In an embodiment, said transmitting the co-existence information comprises broadcasting a message including the co-existence information and a Service Set Identifier (SSID), when the co-existence event is predicted to occur after a predefined threshold time interval. The predefined threshold time interval is associated with a scheduled transmission of a beacon frame.

In an embodiment, said transmitting the broadcast message comprises predicting an idle period to broadcast the broadcast message, and transmitting the broadcast message during the predicted idle period.

In an embodiment, said transmitting the co-existence information comprises transmitting a MU-BCS frame including the co-existence information with SSID during a TXOP acquired by the AP, when the co-existence event is predicted to occur after a completion of a predefined threshold time interval. The predefined threshold time interval is associated with a TXOP duration.

In an embodiment, the MU-BCS frame includes a control frame extension field set to a defined value from a plurality of reserved values indicating the co-existence information and a Receiver Address (RA) field set to a broadcast address.

In an embodiment, the method comprises transmitting a Trigger Frame-Request To Send (TF-RTS) frame after the transmission of the MU-BCS frame, wherein the TF-RTS frame includes a control frame extension field set to a defined value from a plurality of reserved values indicating data transmission. The control frame extension field indicates a type of the TF-RTS frame, and a Receiver Address (RA) of the TF-RTS frame is set to a broadcast address.

In an embodiment, said transmitting the co-existence information comprises transmitting an RWI frame indicating the end of a TXOP and the predefined information, when the co-existence event is predicted to occur after a predefined threshold time interval. The predefined threshold time interval is associated with a TXOP duration. The RWI frame includes a control frame extension field set to a defined value from a plurality of reserved values. The control frame extension field indicates transmission of a MU-BCS frame including the co-existence information. A Receiver Address (RA) of the RWI frame is set to a broadcast address.

In an embodiment, the predefined information comprises transmission of a broadcast message comprising the co-existence information.

In an embodiment, the method comprises transmitting the broadcast message comprising the co-existence information after the transmission of the RWI frame.

In an embodiment, said transmitting the co-existence information comprises embedding the co-existence information in an initial control frame, when the co-existence event is predicted to occur after a predefined threshold time interval. The predefined threshold time interval is associated with a TXOP duration.

In an embodiment, the initial control frame is one of an Initial Control Frame (ICF) and an Initial Control Response (ICR) frame.

In an embodiment, the initial control frame includes a control frame extension field set to a defined value from a plurality of reserved values indicating the co-existence information.

In an embodiment, the co-existence information further comprises a Service Set Identifier (SSID) Identifying A Basic Service Set (BSS) of the AP.

In an embodiment, the co-existence event corresponds to a period during which the AP is expected to be unavailable for wireless communication.

One aspect of the present disclosure provides a method for wireless communication performed by an access point (AP). The method comprises predicting an occurrence of the co-existence event at the AP. The method comprises inserting a co-existence information into a field of a beacon frame. The co-existence information is associated with the co-existence event. The co-existence information includes at least a start time and a duration of the co-existence event. The method comprises transmitting the co-existence information to one or more stations (STAs) via the beacon frame.

In an embodiment, said transmitting of the co-existence information comprises transmitting the co-existence information by inserting the co-existence information into a field of a beacon frame, when the co-existence event is predicted to occur within a predefined threshold time interval. The predefined threshold time interval is associated with a scheduled transmission of the beacon frame.

In an embodiment, the field of the beacon frame is identified by a predefined element Identifier (ID).

One aspect of the present disclosure provides a method for wireless communication performed by an access point (AP). The method comprises predicting an occurrence of the co-existence event at the AP. The method comprises broadcasting a co-existence information in a broadcast message. The co-existence information is associated with the co-existence event. The co-existence information includes at least a start time and a duration of the co-existence event.

In an embodiment, said broadcasting of the co-existence event comprises broadcasting a message including the co-existence information and a Service Set Identifier (SSID) when the co-existence event is predicted to occur after a predefined threshold time interval. The predefined threshold time interval is associated with a scheduled transmission of a beacon frame.

In an embodiment, said broadcasting of the co-existence event comprises predicting an idle period to broadcast the broadcast message, and transmitting the broadcast message during the predicted idle period.

One aspect of the present disclosure provides a method for wireless communication performed by an access point (AP). The method comprises predicting an occurrence of the co-existence event at the AP. The method comprises transmitting a Multi-User Broadcast (MU-BCS) frame including a co-existence information during Transmission Opportunity (TXOP) held by the AP. The co-existence information is associated with the co-existence event. The co-existence information includes at least a start time and a duration of the co-existence event.

In an embodiment, said transmitting of the Multi-User Broadcast (MU-BCS) frame comprises transmitting the MU-BCS frame including the co-existence information with SSID during a TXOP acquired by the AP, when the co-existence event is predicted to occur after a completion of a predefined threshold time interval. The predefined threshold time interval is associated with a TXOP duration.

In an embodiment, the MU-BCS frame includes a control frame extension field set to a defined value from a plurality of reserved values indicating the co-existence information and a Receiver Address (RA) field set to a broadcast address.

In an embodiment, the method comprises transmitting a Trigger Frame-Request To Send (TF-RTS) frame after the transmission of the MU-BCS frame. The TF-RTS frame includes a control frame extension field set to a defined value from a plurality of reserved values indicating data transmission. The control frame extension field indicates a type of the TF-RTS frame. A Receiver Address (RA) of the TF-RTS frame is set to a broadcast address.

One aspect of the present disclosure provides a method for wireless communication performed by an access point (AP). The method comprises predicting an occurrence of the co-existence event at the AP. The method comprises transmitting a Release With Information (RWI) frame indicating the end of the TXOP and a predefined information followed by the MU-BCS frame to one or more stations (STAs). The RWI frame includes a control frame extension field set to a defined value from a plurality of reserved values. The control frame extension field indicates transmission of a MU-BCS frame including the co-existence information. The co-existence information is associated with the co-existence event. The co-existence information includes at least a start time and a duration of the co-existence event. A Receiver Address (RA) of the RWI frame is set to a broadcast address.

In an embodiment, the method comprises transmitting the RWI frame indicating the end of a TXOP and the predefined information, when the co-existence event is predicted to occur after a predefined threshold time interval. The predefined threshold time interval is associated with a TXOP duration.

In an embodiment, the predefined information comprises transmission of a broadcast message comprising the co-existence information.

In an embodiment, the a method for wireless communication performed by an access point (AP). The method comprises transmitting the broadcast message comprising the co-existence information after the transmission of the RWI frame.

One aspect of the present disclosure provides a method for wireless communication performed by an access point (AP). The method comprises predicting an occurrence of the co-existence event at the AP. The method comprises embedding a co-existence information in an initial control frame. The co-existence information includes at least a start time and a duration of the co-existence event. The method comprises transmitting the initial control frame to one or more stations (STAs).

In an embodiment, the embedding of the co-existence information comprises embedding the co-existence information in an initial control frame, when the co-existence event is predicted to occur after a predefined threshold time interval. The predefined threshold time interval is associated with a TXOP duration.

In an embodiment, the initial control frame is one of an Initial Control Frame (ICF) and an Initial Control Response (ICR) frame.

In an embodiment, the initial control frame includes a control frame extension field set to a defined value from a plurality of reserved values indicating the co-existence information.

An aspect of the present disclosure provides a non-transitory computer-readable storage medium. The methods disclosed herein can be performed by one or more computer programs stored on the non-transitory computer-readable storage.

An aspect of the present disclosure provides a non-statutory computer-readable storage medium storing one or more computer programs comprising instructions to perform a method for wireless communication performed by an access point (AP). The method comprises predicting an occurrence of the co-existence event at the AP. The method comprises selecting, based on the prediction, a signaling technique from a plurality of signaling techniques for transmitting a co-existence information associated with the co-existence event. The co-existence information includes at least a start time and a duration of the co-existence event. The method comprises transmitting the co-existence information to one or more stations (STAs) associated with the AP using via the selected signaling technique.

Accordingly, the present disclosure provides various advantages. For example, the present disclosure reduces overhead, power consumption, medium access conflicts, and collisions in the co-existence event.

In this application, unless specifically stated otherwise, the use of the singular includes the plural, and the use of “or” means “and/or.” Furthermore, the use of the terms “including” or “having” is not limiting. Any range described herein will be understood to include the endpoints and all values between the endpoints. Features of the disclosed embodiments may be combined, rearranged, omitted, etc., within the scope of the invention to produce additional embodiments. Furthermore, certain features may sometimes be used to advantage without a corresponding use of other features.

While at least one exemplary embodiment has been presented in the foregoing detailed description, it should be appreciated that a vast number of variations exist.

What is claimed is:

1. An access point (AP) comprising:
at least one processor including processing circuitry; and
memory storing instructions that, when executed by the at least one processor individually or collectively, cause the AP to:
predict an occurrence of the co-existence event at the AP;
select, based on the prediction, a signaling technique from a plurality of signaling techniques for transmitting a co-existence information associated with the co-existence event, wherein the co-existence information includes at least a start time and a duration of the co-existence event; and
transmit the co-existence information to one or more Stations (STAs) associated with the AP using the selected signaling technique.

2. The AP of claim 1, wherein the plurality of signaling techniques comprises two or more of:
inserting the co-existence information into a field of a beacon frame;
broadcasting the co-existence information in a broadcast message;
transmitting a Multi-User Broadcast (MU-BCS) frame including the co-existence information during Transmission Opportunity (TXOP) held by the AP;
transmitting a Release With Information (RWI) frame indicating the end of the TXOP and a predefined information followed by the MU-BCS frame; and
embedding the co-existence information in an initial control frame.

3. The AP of claim 1, wherein said transmitting of the co-existence information comprises:
transmitting the co-existence information at least by inserting the co-existence information into a field of a beacon frame, when the co-existence event is predicted to occur within a predefined threshold time interval, and wherein the predefined threshold time interval is associated with a scheduled transmission of the beacon frame.

4. The AP of claim 3, wherein the field of the beacon frame is identified by a predefined element Identifier (ID).

5. The AP of claim 1, wherein said transmitting of the co-existence information comprises:
broadcasting a message including the co-existence information and a Service Set Identifier (SSID), when the co-existence event is predicted to occur after a predefined threshold time interval, and wherein the predefined threshold time interval is associated with a scheduled transmission of a beacon frame.

6. The AP of claim 5, wherein said transmitting of the broadcast message comprises:
predicting an idle period to broadcast the broadcast message; and
transmitting the broadcast message during the predicted idle period.

7. The AP of claim 1, wherein said transmitting of the co-existence information comprises:
transmitting a MU-BCS frame including the co-existence information with SSID during a TXOP acquired by the AP, when the co-existence event is predicted to occur after a completion of a predefined threshold time interval, and wherein the predefined threshold time interval is associated with a TXOP duration.

8. The AP of claim 7, wherein the MU-BCS frame includes a control frame extension field set to a defined value from a plurality of reserved values indicating the co-existence information and a Receiver Address (RA) field set to a broadcast address.

9. The AP of claim 7, the instructions, when executed by the at least one processor individually or collectively, cause the AP to:
transmit a Trigger Frame-Request To Send (TF-RTS) frame after the transmission of the MU-BCS frame, wherein the TF-RTS frame includes a control frame extension field set to a defined value from a plurality of reserved values indicating data transmission, wherein the control frame extension field indicates a type of the TF-RTS frame, and wherein a Receiver Address (RA) of the TF-RTS frame is set to a broadcast address.

10. The AP of claim 1, wherein said transmitting of the co-existence information comprises:
transmitting an RWI frame indicating the end of a TXOP and the predefined information, when the co-existence event is predicted to occur after a predefined threshold time interval, and wherein the predefined threshold time interval is associated with a TXOP duration, wherein the RWI frame includes a control frame extension field set to a defined value from a plurality of reserved values, wherein the control frame extension field indicates transmission of a MU-BCS frame including the co-existence information and wherein a Receiver Address (RA) of the RWI frame is set to a broadcast address.

11. The AP of claim 10, wherein the predefined information comprises transmission of a broadcast message comprising the co-existence information.

12. The AP of claim 10, the instructions, when executed by the at least one processor individually or collectively, cause the AP to:
transmit the broadcast message comprising the co-existence information after the transmission of the RWI frame.

13. The AP of claim 1, wherein said transmitting of the co-existence information comprises:
embedding the co-existence information in an initial control frame, when the co-existence event is predicted to occur after a predefined threshold time interval, and wherein the predefined threshold time interval is associated with a TXOP duration.

14. The AP of claim 13, wherein the initial control frame is one of an Initial Control Frame (ICF) and an Initial Control Response (ICR) frame.

15. The AP of claim 13, wherein the initial control frame includes a control frame extension field set to a defined value from a plurality of reserved values indicating the co-existence information.

16. The AP of claim 1, wherein the co-existence information further comprises a Service Set Identifier (SSID) Identifying A Basic Service Set (BSS) of the AP.

17. The AP of claim 1, wherein the co-existence event corresponds to a period during which the AP is expected to be unavailable for wireless communication.

18. A method for wireless communication performed by an access point (AP), the method comprising:
predicting an occurrence of the co-existence event at the AP;
selecting, based on the prediction, a signaling technique from a plurality of signaling techniques for transmitting a co-existence information associated with the co-existence event, wherein the co-existence information includes at least a start time and a duration of the co-existence event; and
transmitting the co-existence information to one or more Stations (STAs) associated with the AP using via the selected signaling technique.

19. The method of claim 18, wherein the plurality of signaling techniques comprises two or more of:
inserting the co-existence information into a field of a beacon frame;
broadcasting the co-existence information in a broadcast message;
transmitting a Multi-User Broadcast (MU-BCS) frame including the co-existence information during Transmission Opportunity (TXOP) held by the AP;
transmitting a Release With Information (RWI) frame indicating the end of the TXOP and a predefined information followed by the MU-BCS frame; and
embedding the co-existence information in an initial control frame.

20. The method of claim 18, wherein said transmitting the co-existence information comprises:
inserting the co-existence information into a field of a beacon frame, when the co-existence event is predicted to occur within the predefined threshold time interval, wherein the predefined threshold time interval is associated with a scheduled transmission of the beacon frame.
